(19) United States
(12) Patent Application Publication
(10) Pub. No.: US 2007/0262595 A1
(43) Pub. Date: Nov. 15, 2007

(54) Automotive door striker

(76) Inventor: Lawrence W. Johnson, Taylor, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/429,008

(22) Filed: May 5, 2006

(51) Int. Cl. E05B 15/02

(52) U.S. Cl. 292/340

(57) ABSTRACT

A door striker that may be used in many applications, including numerous applications throughout the automotive industry, includes an improved door striker that is made of a single piece of material. The door striker is stamped and drawn to its final configuration. The edges of the posts of the door striker are rolled and/or curled to provide structurally integrity to the door striker. In addition, the rolled edges provide a compatible mating surface for the associated door latching mechanism. Moreover, the bolt holes formed in the door striker include retaining features to hold the bolts in place during shipment of the door striker, prior to assembly. The bolts may then be manually pushed or threaded into the mounting holes on the automobile.

### FIELD OF THE INVENTION

The present invention relates generally to a door striker device that may be used with an automobile.

### BACKGROUND OF THE INVENTION

It is known that door strikers are used on automobiles to facilitate the latching and unlatching of the door to the frame of the automobile and thus the opening and closing of the automobile's door. More specifically, the door strikers are mounted to the frame of the automobile and the door includes a latch mechanism that engages the door striker to latch and hold the door to the door striker. By operating the handle of the door, the latch mechanism will unlatch from the door striker, thereby permitting the door to open.

The known door strikers are made of two components that are assembled together—a striker plate and a striker bar. The striker plate is typically made of flat sheet metal that is fastened to the automobile's frame. The striker bar is typically a bent wire rod having ends that are typically orbitally riveted, or sometimes staked, to the striker plate.

The known two component assembly of the door striker suffers from certain drawbacks. The known door strikers are generally costly to manufacture and complex to assemble because of the two component assembly. For example, orbitally riveting or staking the ends of the striker bar to the striker plate adds significant time, cost and complexity to the assembly of the components. Because the striker bar is made of bent wire rod, the shape and configuration of the striker bar is limited by the use of this wire rod. Still other drawbacks and disadvantages of the known door strikers exist, which are overcome by the present invention.

### SUMMARY OF THE INVENTION

In an exemplary embodiment, the present invention includes an improved door striker that is made of a single piece of material that is stamped and drawn to its final configuration. That is, the striker bar is formed integral with the striker plate as a one-piece construction. With the invention, the edges of the posts that form the striker bar are rolled and/or curled to provide structurally integrity to the door striker. Additionally, the rolled edges provide a compatible mating surface for the associated door latching mechanism. Moreover, the bolt holes formed in the door striker plate include retaining features to hold the bolts in place during shipment of the door striker and prior to assembly. The bolts can then be manually pushed or threaded into the mounting holes on the automobile frame.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an isometric view of an exemplary embodiment of a door striker of the present invention.

FIG. 2 is a top plan view of an alternative embodiment of the door striker of FIG. 1.

FIG. 3 is an isometric view of the door striker of FIG. 2.

FIG. 4 is a top plan view of another alternative embodiment of the door striker of FIG. 1.

FIG. 5 is an isometric view of the door striker of FIG. 4.

FIG. 6 is a top plan view of a yet another alternative embodiment of the door striker of FIG. 1.

FIG. 7 is an isometric view of the door striker of FIG. 6.

FIG. 8 is a top plan view of still another alternative embodiment of the door striker of FIG. 1.

FIG. 9 is an isometric view of the door striker of FIG. 8.

FIGS. 10a-10j depict an exemplary method of manufacturing an exemplary door striker of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

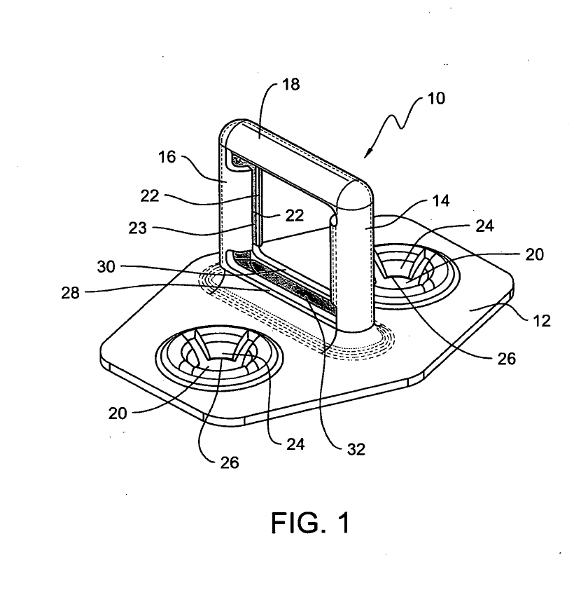

The present invention may be embodied in many forms. In one exemplary embodiment depicted in FIG. 1, the present invention is directed to a one-piece door striker 10 that may be used in numerous applications, including in automobiles. The door striker 10 is made of a high strength, light-weight steel, though other materials may be used to make the door striker. In an exemplary embodiment, the door striker 10 may be stamped and drawn to form the configuration depicted in FIG. 1. The striker 10 may be a unitary, one-piece device that defines a striker plate 12, two striker posts 14, 16 formed integral with the striker plate 12 and extending outwardly from the striker plate 12, and a striker bar 18 joined between the striker posts 14, 16. The striker plate 12 defines one or more mounting holes 20 that further define features for retaining mounting bolts to the striker plate during shipment of the door striker and prior to assembly, as described below.

The striker plate 12 may define a generally planar configuration for mounting to a mating surface on a vehicle, for example. Alternatively, the striker plate may define numerous other configurations that permit the mounting of the striker plate to a mounting surface. The striker plate 12 may define one or more mounting holes 20 each of which may include alignment and bolt retention tabs 24. The tabs 24 extend outwardly from the striker plate 12 and toward the center of each hole 20. The tabs 24 may be four tabs 24 spaced equidistant around the hole 20 and may further define concave-shaped ends 26 that are configured to mate with the cylindrical shape of the bolt, not shown. The tabs 24 will retain the bolt, not shown, in the hole 20 during shipment of the door striker 10 and prior to assembly. The tabs 24 may be further used to align the striker plate 12 to the mounting surface on the vehicle. In other words, the ends 26 of the tabs 24 may align with the mounting holes on the mounting surface of the vehicle to facilitate the alignment and mounting of the door striker to the mounting surface. As should be appreciated, other shapes and configurations of the tabs 24, and other means for retaining the bolts in the holes 20, are possible with the invention. The invention is therefore not limited to the particular configuration and spacing of the tabs 24 illustrated in FIG. 1. The mounting holes 20 may also be counter-sunk to allow the bolt, not shown, to be recessed in the mounting hole 20, as understood in the art.

Each striker post 14, 16 may be drawn and punched to form the depicted configuration. Each post extends outwardly from the striker plate 12 and may be rolled and/or curled to define the cylindrical post configuration depicted in FIG. 1. The rolled and/or curled features provide the posts with the structural integrity necessary for a door striker. The posts 14, 16 define opposing edges 22 that further define a slot 23 between the edges 22.

Formed with and joining the striker posts 14, 16 is the striker bar 18. The striker bar 18 may be rolled and/or curled to define the cylindrical configuration depicted in FIG. 1. The striker bar 18 is configured to receive the door latch mechanism of the automobile, not shown, to thereby latch the door to the door striker. The striker bar 18 may define numerous other configurations or profiles, including the illustrated cylindrical configuration, or a square, rectangular or wedge configuration.

The striker plate 12 further defines reinforcing ribs 28, 30 that form with and join the posts 14, 16. The reinforcing ribs 28, 30 provide additional structural integrity and support to the posts 14, 16 at the base of each post. The ribs 28, 30 form a slot 32 between the ribs.

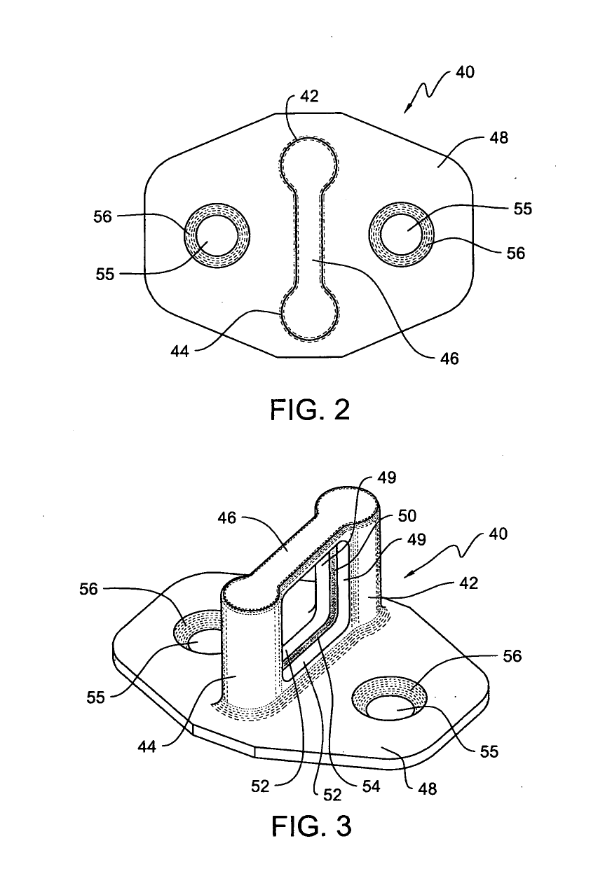

Referring to FIGS. 2 and 3, an alternative embodiment of the door striker is depicted. The door striker 40 may be stamped and drawn to form the depicted configuration and may define striker posts 42, 44 that are rolled/curled to define the depicted cylindrical configuration. Joined between and formed integral with the striker posts 42, 44 is a cylindrical striker bar 46. The striker bar 46 defines a diameter that is less than the diameter of the striker posts. The striker posts and striker bar are formed integral with the striker plate 48 and form edges 49 that further define a slot 50 between the edges 49. Reinforcing ribs 52 defining a slot 54 are also formed with the striker plate 48 and join the striker posts at their base to provide additional structural support to the posts. The striker plate 48 may further define one or more holes 55 that may further define counter-sunk mounting edges 56. The mounting holes 54 may further include the bolt retention tabs, described above. Other configurations of the striker posts and bar are possible with this embodiment.

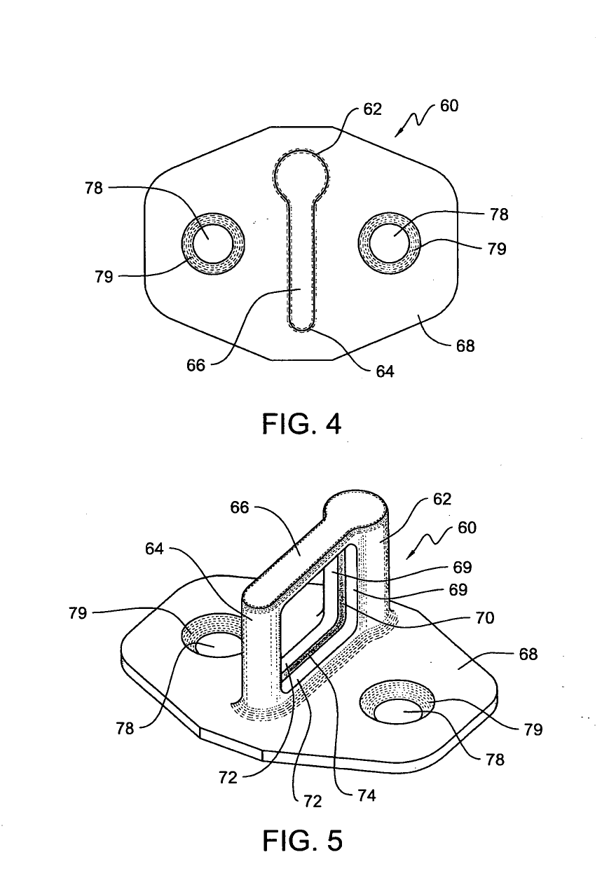

Referring to FIGS. 4 and 5, another alternative door striker 60 that may be stamped and drawn to form the depicted configuration includes striker posts 62, 64 that are joined with and connected by striker bar 66. The striker posts and striker bar may be rolled/curled to provide structural integrity to the striker posts and bar. The striker posts are formed integral with the striker plate 68 and define opposing edges 69 that further define a slot 70 between the edges 69. With this embodiment, the striker post 62 defines a diameter that is greater than the diameters of the striker post 64 and striker bar 66. As depicted, the striker post 64 and the striker bar 66 have generally similar profiles. Similar to the other embodiments, the door striker 60 may include reinforcing ribs 72 that define a slot 74, and the striker plate 68 may further define one or more mounting holes 78 that may further include counter-sunk edges 79. Similar to the other embodiments, the holes 78 may include the bolt retention features described above.

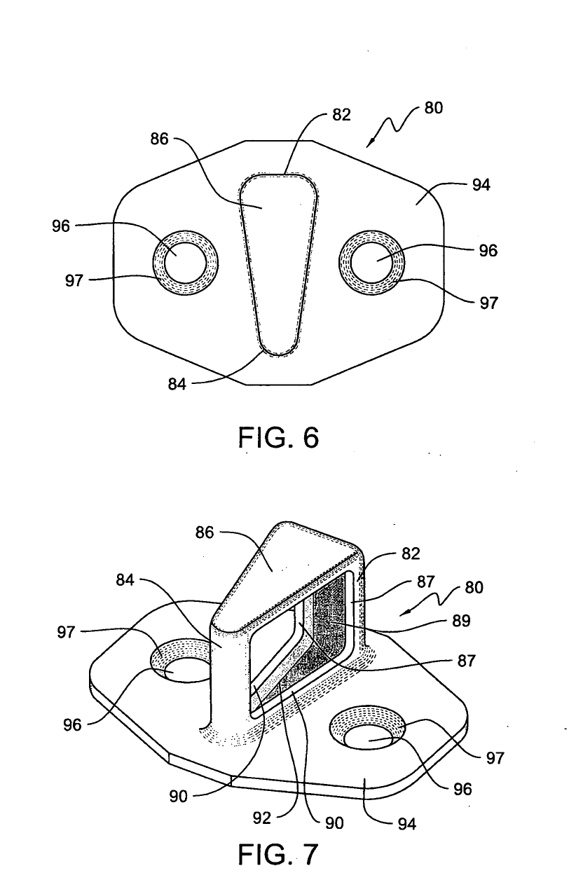

Referring to FIGS. 6 and 7, yet another alternative door striker 80 that may be stamped and drawn to form the depicted configuration includes striker posts 82, 84 that are joined with and connected by striker bar 86 that defines a wedge-shaped configuration. Similar to the other embodiments, the striker posts and striker bar may be rolled/curled to provide structural integrity to the striker posts and bar. The striker posts 82, 84 are formed integral with the striker plate 88 and the striker post 82 defines a diameter or profile that is greater than the diameter or profile of the striker post 84, as shown in FIG. 7. The striker posts further define opposing edges 87 that further define a slot 89 between the edges 87. Similar to the other embodiments, the door striker 80 may include reinforcing ribs 90 that define an opening 92, and a striker plate 94 that may further define one or more mounting holes 96 that may further include counter-sunk edges 97. Similar to the other embodiments, the holes 96 may include the bolt retention features described above.

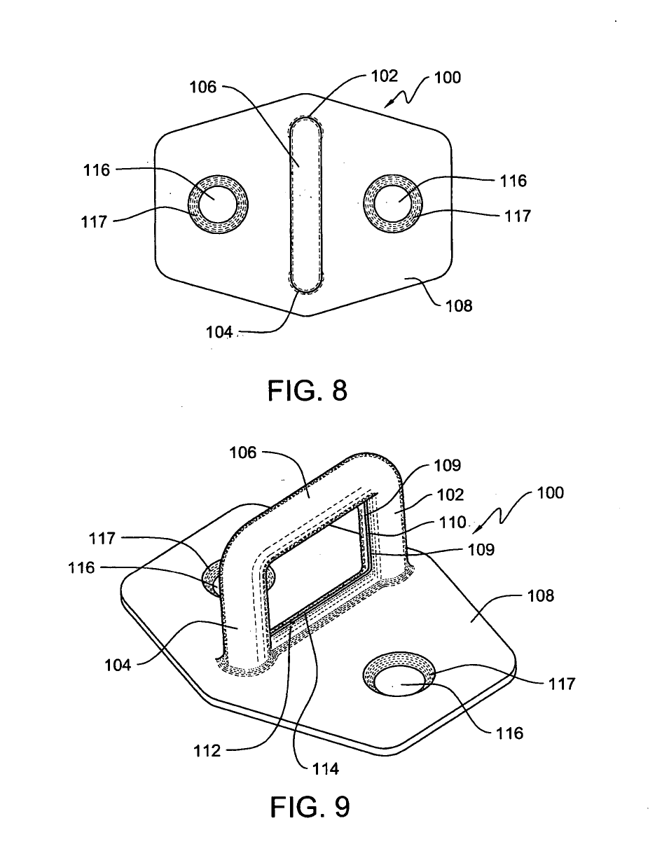

Referring to FIGS. 8 and 9, still another alternative door striker 100 that may be stamped and drawn to form the depicted configuration includes striker posts 102, 104 that are joined with and connected by striker bar 106. The striker posts and striker bar may be rolled/curled to provide structural integrity to the striker posts and bar and, in this embodiment, may define a uniform configuration. The striker posts are formed integral with the striker plate 108 and similar to the other embodiments define edges 109 that form a slot 110. With this embodiment, the striker posts 102, 104 and striker bar 106 define cross-sections that are uniform. Again, similar to the other embodiments, the door striker 100 may include reinforcing ribs 112 that define a slot 114. The striker plate 108 may further define one or more mounting holes 116 that may further include counter-sunk edges 117. Similar to the other embodiments, the holes 116 may include the bolt retention features described above.

It should be understood that with each of the above embodiments, the shape and configuration of the striker posts and bars may vary depending on the application. That is, depending on the application and the particular latch mechanism for which the door striker will be used, the shape and configuration of the door striker may vary to ensure a proper engagement of the latch mechanism to the door striker.

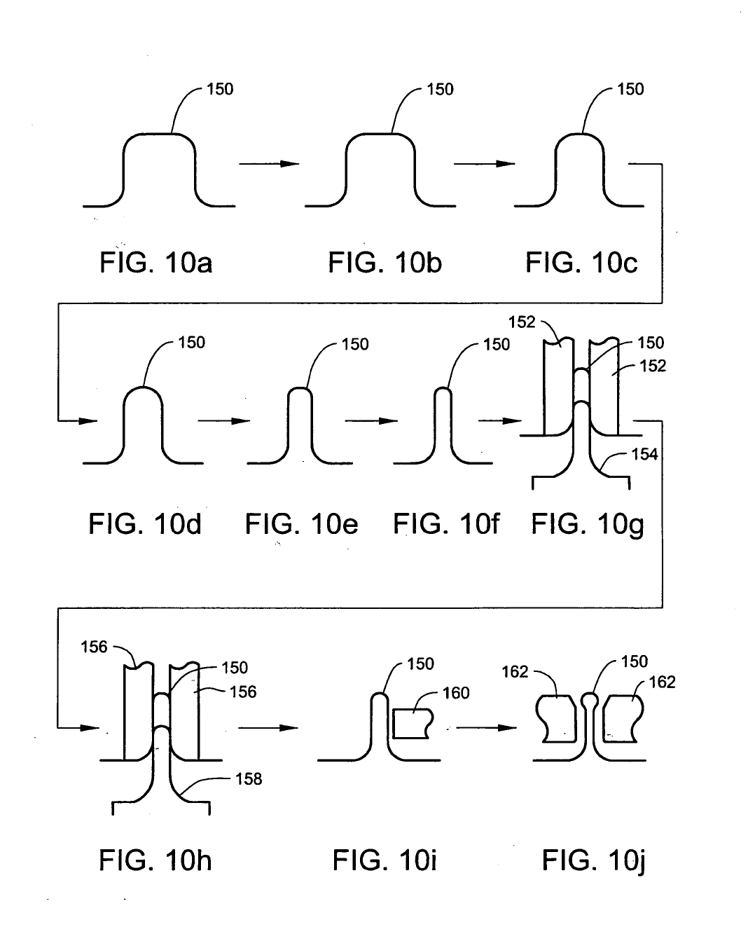

Referring to FIGS. 10a-10j, an exemplary method of manufacturing the door striker may include stamping and drawing the material that forms the door striker to form the final configuration of the door striker. As depicted by FIGS. 10a-10f, a material 150, such as high strength, light-weight steel, may be formed using one or more punches and dies that generate a deep extruded draw. These figures illustrate the progression of the various possible forming stages of the material 150 that eventually result in an exemplary configuration depicted in FIG. 10f.

FIGS. 10g-10h are known as the “cramming” stages during which punches, dies and cams may be used to taper and neck down the material 150 to a closer-to-final-form striker. As depicted in FIG. 10g, a punch 154 may be positioned partially in the material 150. More specifically, in one embodiment, the punch 154 may be positioned approximately half-way into the material 150. The punch 154 may be used to maintain smooth sidewalls of the material 150, to prevent collapsing of the sidewalls of the material 150, known as “tin-canning” of the material, and to maintain the depth of the formed material 150. A die 152 may be used to further form the sidewalls of the material 150. During this step, as the die 152 closes on the material 150, the punch 154 retracts from the material 150 to permit the die 152 to further form the material 150. As illustrated by FIG. 10h, an additional forming stage may include a punch 158 having a slightly smaller cross-section that may be inserted half-way into the material 150. A die 156 defining a slightly narrower gap between the walls of the die 156 may close on the material 150, while the punch 158 withdraws from the material 150. The die 156 further forms the material 150.

As shown in FIGS. 10i-10j, side punch 160 and side cam 162 may be used to further define the side walls of the material 150 and to further form the material 150 closer to its final configuration. The side punch 160 may be used to form the cutout in the door striker, such as the opening formed between the posts 14, 16 and bar 18, as illustrated in FIG. 1. The side cam 162 may be used to break sharp edges or corners left after the side punch 160 cuts out the opening formed in the striker to give the door striker a more appealing appearance. The side cam 162 may also be used to roll/curl the posts and bars, as illustrated by FIG. 1, to improve the structural integrity of the posts and bars. It should be understood that during these stages, other possible punches and cams may be used to define the material 150 and form it to its desired configuration.

As can be appreciated, the various manufacturing stages depicted in FIGS. 10a-j are merely exemplary of the possible stages that could be implemented and used to form the door striker. Additionally, the punches, dies and cams are also exemplary of the numerous types and shapes of punches, dies and cams that could be used with the invention to form the desired configuration of the door striker. Moreover, various punches and cams may be used to form the mounting holes and bolt retaining tabs, described above, that are formed in the striker plate of the door striker.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A one-piece door striker comprising:
a striker plate defining at least one mounting hole, the at least one mounting hole defining a hole center,
at least one bolt-retaining tab formed around the at least one mounting hole and extending toward the hole center,
a first post formed integral with the strike plate,
a second post formed integral with the striker plate, and
a striker bar formed integral with the first and second posts.

2. The door striker of claim 1 further comprising a plurality of bolt-retaining tabs formed around the at least one mounting hole, each of the bolt-retaining tabs extending toward the hole center.

3. The door striker of claim 1 wherein the first and second posts define edges formed thereon, and wherein a slot is formed between the edges.

4. The door striker of claim 1 wherein the striker bar defines a cylindrical configuration.

5. The door striker of claim 1 wherein the striker bar defines a wedge-shaped configuration.

6. The door striker of claim 1 wherein the first post defines a first diameter, and wherein the second post defines a second diameter, and wherein the first diameter is larger than the second diameter.

7. The door striker of claim 1 further comprising reinforcing ribs formed integral with the striker plate and that join the first and second posts.

8. The door striker of claim 7 wherein a slot is formed between the reinforcing ribs.

9. The door striker of claim 1 further comprising at least two mounting holes and a plurality of bolt-retaining tabs formed around each of the mounting holes.

10. A stamped and drawn one-piece door striker comprising:
a striker plate defining at least one mounting hole that further defines a plurality of bolt-retaining tabs formed around the at least one mounting hole, the at least one mounting hole defining a hole center, and the plurality of bolt-retaining tabs extending toward the hole center,
a first post formed integral with the strike plate and extending outwardly from the striker plate,
a second post formed integral with the striker plate and extending outwardly from the striker plate, and
a striker bar formed integral with the first and second posts.

11. The door striker of claim 10 further comprising at least two mounting holes and a plurality of bolt-retaining tabs formed around each of the mounting holes.

12. The door striker of claim 10 wherein the first and second posts are rolled to define opposing edges, and wherein a slot is formed between the edges.

13. The door striker of claim 10 wherein the striker bar defines a cylindrical configuration.

14. The door striker of claim 10 wherein the striker bar defines a wedge-shaped configuration.

15. The door striker of claim 10 wherein the first post defines a first diameter, and wherein the second post defines a second diameter, and wherein the first diameter is larger than the second diameter.

16. The door striker of claim 10 further comprising reinforcing ribs formed integral with the striker plate and that join the first and second posts.

17. The door striker of claim 16 wherein a slot is formed between the reinforcing ribs.

18. A method of forming a one-piece door striker comprising:
providing a material to be formed into the door striker,
drawing the material with at least one punch and at least one die, the material forming at least one side wall,
inserting a second punch partially into the material,
retracting the second punch while a second die closes on the material,
punching the at least one side wall to define a cut-out in the side wall, and
camming the at least one side wall to further form the material.

19. The method of claim 18 further comprising forming at least two mounting holes in the material.

20. The method of claim 18 wherein the drawing step includes using a plurality of punches and a plurality of dies.
